(19) United States
(12) Patent Application Publication
(10) Pub. No.: US 2025/0301300 A1
(43) Pub. Date: Sep. 25, 2025

(54) COMMUNICATION METHOD AND COMMUNICATION APPARATUS

(71) Applicant: HUAWEI TECHNOLOGIES CO., LTD., Shenzhen (CN)

(72) Inventors: Lei HUANG, Singapore (SG); Xun YANG, Singapore (SG)

(21) Appl. No.: 19/230,389

(22) Filed: Jun. 6, 2025

Related U.S. Application Data
(63) Continuation of application No. PCT/CN2022/137621, filed on Dec. 8, 2022.

(51) Int. Cl. H04W 8/00; H04B 17/318; H04W 52/02

(52) U.S. Cl. CPC H04W 8/005; H04B 17/318; H04W 52/0235

(57) ABSTRACT

Embodiments of this application may be applied to the IEEE Std 802.11a/b/g, 802.11n, 802.11ac, 802.11ax, 802.11ba, 802.11be, Wi-Fi 7, EHT, Wi-Fi 8, UHR, Wi-Fi AI or their next generation standards, a UWB based wireless personal local area network system, or a sensing system. The embodiments provide a communication method and a communication apparatus, in which discovery information for an AP affiliated with an AP MLD includes information of the AP MLD. In this way, when a station receives a discovery frame sent by the AP, the station is able to use the information of the AP MLD in the discovery information for the AP to determine that the AP is affiliated with the AP MLD. Thus, the station is able to discover the AP and determine the AP MLD with which the AP is affiliated, and then realize the discovery of the AP MLD.

### CROSS-REFERENCE TO RELATED APPLICATIONS

This application is a continuation of International Application No. PCT/CN2022/137621, filed on Dec. 8, 2022, the disclosure of which is hereby incorporated by reference in its entirety.

### TECHNICAL FIELD

Embodiments of the present application relate to the field of wireless communication, and more particularly, to a communication method and a communication apparatus.

### BACKGROUND

A wake-up radio (WUR) non-access point (non-AP) station (STA) is a non-high throughout (non-HT), high throughout (HT), very high throughout (VHT), or high efficiency (HE) non-AP STA that is capable of receiving WUR physical protocol data units (PPDUs) and supports the WUR operation. A WUR access point (AP) is a non-HT, HT, VHT, or HE AP that is capable of transmitting WUR PPDUs and supports the WUR operation.

The WUR operation at least includes WUR discovery. The WUR discovery is mainly used for ultra-low power location scanning and roaming scanning. Regarding the WUR facilitated location scanning, a mobile device scans one or more WUR discovery channels using its WUR receiver, and uses the signal strength measured from WUR PPDUs and received from neighbouring APs to provide additional information for location services on the mobile device. The WUR facilitated location scanning provides an ultra-low power location scanning mechanism due to much less power consumption by the WUR receiver than a main radio receiver. Regarding the WUR facilitated roaming scanning, a mobile device passively scans multiple WUR discovery channels using its WUR receiver, and collects basic information about neighbouring APs. The collected information can be used to facilitate the mobile device's roaming decisions. The WUR facilitated roam scanning provides an ultra-low power roaming scanning mechanism. In addition, ultra-low power roaming scanning can be performed quite frequently in the background, and thus roaming information can be readily available whenever needed, resulting in reduced roaming latency.

However, a WUR discovery mechanism shown above is designed to assist in discovery of a WUR AP which is based on a single link operation. As a result, the WUR discovery mechanism above cannot be directly applicable to discovery of a WUR AP multi-link device (MLD) which is based on a multi-link operation (MLO).

Therefore, how to enhance the WUR discovery mechanism for WUR AP MLD discovery is a challenge.

### SUMMARY

Embodiments of the present application provide a communication method and apparatus, and the communication method and apparatus are helpful to discover an AP MLD.

According to a first aspect, provided is a communication method, including:
receiving, by a station, a first frame, where the first frame includes discovery information for a first AP affiliated with an AP MLD, and the discovery information for the first AP includes information of the AP MLD;
receiving, by the station, a second frame from the first AP, where the second frame is used to discover the first AP; and
determining, by the station, that the first AP is affiliated with the AP MLD according to the discovery information for the first AP and the second frame.

Optionally, the first frame is a Beacon frame or a Probe Response frame.

Optionally, the second frame is a WUR Discovery frame.

The AP that sends the first frame and the second frame may be same or different. In other words, the first frame may be sent by the first AP or another AP.

According to the method above, the discovery information for the first AP affiliated with the AP MLD includes the information of the AP MLD. In this way, when the station discovers the first AP, that is, the station receives the second frame sent by the first AP, the station is able to use the information of the AP MLD in the discovery information for the first AP to determine that the first AP is affiliated with the AP MLD. Thus, the station is able to discover an AP and determine an AP MLD with which the AP is affiliated, and then realize the discovery of the AP MLD.

In an embodiment of the first aspect, the information of the AP MLD includes at least one of the following parameters: an AP MLD ID of the AP MILD, a link ID of the first AP within the AP MLD or a medium access control (MAC) address of the AP MLD.

According to this embodiment, the station is able to determine an AP MLD with which the AP is affiliated, its link ID within that AP MLD, or the MAC address of the AP MLD with which the AP is affiliated.

In an embodiment of the first aspect or any one of the embodiments of the first aspect, the first frame further includes discovery information for at least one second AP and/or discovery information for at least one third AP, where each second AP is an AP affiliated with the AP MHLD, discovery information for each second AP includes the information of the AP MLD, each third AP is an AP affiliated with a neighboring AP MLD of the AP MLD, and discovery information for each third AP includes information of an AP MLD with which the third AP is affiliated.

According to this embodiment, the first frame also includes discovery information for APs, each of which is an AP affiliated with the same AP MLD as the first AP or an AP which is affiliated with a neighboring AP MLD. This information can be used to facilitate the discovery of the AP MLD and the station's roaming.

In an embodiment of the first aspect or any one of the embodiments of the first aspect, the first frame further includes discovery information for at least one fourth AP, where the fourth AP is a neighboring AP of the first AP, and discovery information for each fourth AP includes information of the fourth AP.

According to this embodiment, the first frame sent by the first AP also includes the discovery information for APs, each of which is a neighboring AP of the first AP. This information can be used to facilitate the station's roaming.

In an embodiment of the first aspect or any one of the embodiments of the first aspect, a type of the second frame is different from that of a legacy WUR Discovery frame, and the second frame includes a compressed MAC address of the AP MLD and primary channel information of at least one second AP affiliated with the AP MLD.

According to this embodiment, the second frame may carry essential information of all APs affiliated with the AP MLD. Thus, the station may perform scanning on a single discovery channel per AP MLD. Since the station is able to obtain essential information of an AP MLD by scanning a single discovery channel, scanning latency and power consumption can be significantly reduced.

In an embodiment of the first aspect or any one of the embodiments of the first aspect, the second frame specifically includes a Type subfield, an ID subfield, a Type Dependent Control subfield, a Link ID Bitmap subfield and an Operating Class And Channel List subfield, where the Type subfield is used to indicate the type of the second frame, the ID subfield is set to 12 least significant bits (LSBs) of the compressed MAC address of the AP MLD, the Type Dependent Control subfield is set to 12 most significant bits (MSBs) of the compressed MAC address of the AP MLD, the Link ID Bitmap subfield is used to indicate a link ID of each link for which a corresponding basic service set (BSS) is being advertised by the second frame, link IDs indicated by the Link ID Bitmap subfield include a link ID of the first AP and a link ID of the at least one second AP, the Operating Class And Channel List subfield is used to indicate primary channel information of each BSS that is being advertised by the second frame, and the primary channel information indicated by the Operating Class And Channel List subfield includes primary channel information of the first AP and the primary channel information of the at least one second AP.

In an embodiment of the first aspect or any one of the embodiments of the first aspect, the second frame specifically includes a Type subfield, an ID subfield, a Type Dependent Control subfield and a plurality of information groups, where the Type subfield is used to indicate the type of the second frame, the ID subfield is set to 12 LSBs of the compressed MAC address of the AP MLD, the Type Dependent Control subfield is set to 12 MSBs of the compressed MAC address of the AP MLD, the plurality of information groups are used to indicate primary channel information of each BSS that is being advertised by the second frame, the primary channel information indicated by the plurality of information groups includes primary channel information of the first AP and the primary channel information of the at least one second AP, each of the plurality of information groups includes a Link ID subfield and an Operating Class And Channel subfield, the Link ID subfield is used to indicate a link ID of a link for which a corresponding BSS is being advertised by the second frame, and the Operating Class And Channel subfield is used to indicate primary channel information of the corresponding BSS indicated by the Link ID subfield in a same information group.

In an embodiment of the first aspect or any one of the embodiments of the first aspect, where the receiving the second frame from the first AP further includes:
generating, by the station, a request primitive on a system management entity (SME), where the request primitive includes a discovery channel list which is used to indicate one or more discovery channels to be scanned;
performing, by the station, scanning on the one or more discovery channels to receive the second frame on a MAC layer; and
returning, by the station, a confirm primitive to the SME based on the second frame on the MAC layer;
where the confirm primitive includes at least one of the following parameters: an indicator used to indicate that an AP MLD is discovered, a Transmitter ID used to indicate 12 LSBs of the compressed MAC address of the AP MLD; a CompressedMLDMACAddress_MSB used to indicate 12 MSBs of the compressed MAC address of the AP MLD; a Compressed Service Set Identifier (SSID) used to indicate 16 LSBs of a short SSID of the AP MLD; a Link ID Bitmap or Link ID List used to specify one or more APs affiliated with the AP MLD; an OperatingChannelList used to specify a primary channel of each of the one or more APs affiliated with the AP MLD; and a Received Signal Strength Indicator (RSSI) used to indicate an RSSI of the first AP.

In an embodiment of the first aspect or any one of the embodiments of the first aspect, the request primitive further includes at least one of the following parameters: an indicator used to indicate that an AP MLD is to be discovered; a Transmitter ID used to indicate 12 LSBs of a compressed MAC address of the AP MLD to be discovered; a CompressedMLDMACAddress_MSB used to indicate 12 MSBs of the compressed MAC address of the AP MLD to be discovered; and a Compressed SSID used to indicate 16 LSBs of a short SSID of the AP MLD to be discovered.

In an embodiment of the first aspect or any one of the embodiments of the first aspect, the method further includes:
receiving, by the station, a third frame from the first AP, where the third frame includes a compressed MAC address of the AP MLD and primary channel information of at least one second AP affiliated with the AP MLD, and a type of the third frame is different from that of a legacy WUR Discovery frame.

According to this embodiment, the station obtains essential information of an AP MLD through the second frame and the third frame sent by a same AP affiliated with the AP MLD. Thus, the station may perform scanning on a single discovery channel per AP MHLD. Since the station is able to obtain essential information of an AP MLD by scanning a single discovery channel, scanning latency and power consumption can be significantly reduced.

In an embodiment of the first aspect or any one of the embodiments of the first aspect, the first frame includes a WUR Discovery element, and the discovery information for the first AP is carried in the WUR Discovery element; or the first frame includes a WUR Discovery element and a reduced neighbor report (RNR) element, the WUR Discovery element and the RNR element include the information of the AP MLD, the RNR element includes a part of the discovery information for the first AP, and the WUR Discovery element does not include the part of the discovery information for the first AP.

According to this embodiment, for an AP affiliated with an AP MLD, its discovery information included in the discovery element and its regular discovery information included in the RNR element in the same frame can be associated via the information of the AP MHLD. Such an association between the discovery element and the RNR element can be utilized to minimize the overhead.

According to a second aspect, provided is a communication method. The technical effect of the method of the second aspect or any one of the embodiments of the second aspect could refer to that of the first aspect, and is not repeated here.

The method provided in the second aspect includes:
generating, by an AP MLD, a first frame through a first AP affiliated with the AP MLD, where the first frame includes discovery information for the first AP, and the discovery information for the first AP includes information of the AP MLD; and
transmitting, by the AP MLD, the first frame through the first AP.

In an embodiment of the second aspect, the information of the AP MLD includes at least one of the following parameters: an AP MLD ID of the AP MLD, a link ID of the first AP within the AP MLD or a MAC address of the AP MLD.

In an embodiment of the second aspect or any one of the embodiments of the second aspect, the first frame further includes discovery information for at least one second AP and/or discovery information for at least one third AP, where each second AP is an AP affiliated with the AP MLD, discovery information for each second AP includes the information of the AP MLD, each third AP is an AP affiliated with a neighboring AP MLD of the AP MLD, and discovery information for each third AP includes information of an AP MLD with which the third AP is affiliated.

In an embodiment of the second aspect or any one of the embodiments of the second aspect, the first frame further includes discovery information for at least one fourth AP, where each fourth AP is a neighboring AP of the first AP, and discovery information for each fourth AP includes information of the fourth AP.

In an embodiment of the second aspect or any one of the embodiments of the second aspect, the method further includes: transmitting, by the AP MLD, a second frame through the first AP based on the discovery information for the first AP, where the second frame is used to discover the first AP.

In an embodiment of the second aspect or any one of the embodiments of the second aspect, a type of the second frame is different from that of a legacy WUR Discovery frame, and the second frame includes a compressed MAC address of the AP MLD and primary channel information of at least one second AP affiliated with the AP MLD.

In an embodiment of the second aspect or any one of the embodiments of the second aspect, the second frame specifically includes a Type subfield, an ID subfield, a Type Dependent Control subfield, a Link ID Bitmap subfield and an Operating Class And Channel List subfield, where the Type subfield is used to indicate the type of the second frame, the ID subfield is set to 12 LSBs of the compressed MAC address of the AP MLD, the Type Dependent Control subfield is set to 12 MSBs of the compressed MAC address of the AP MLD, the Link ID Bitmap subfield is used to indicate a link ID of each link for which a corresponding BSS is being advertised by the second frame, link IDs indicated by the Link ID Bitmap subfield include a link ID of the first AP and a link ID of the at least one second AP, the Operating Class And Channel List subfield is used to indicate primary channel information of each BSS that is being advertised by the second frame, and the primary channel information indicated by the Operating Class And Channel List subfield includes primary channel information of the first AP and the primary channel information of the at least one second AP.

In an embodiment of the second aspect or any one of the embodiments of the second aspect, the second frame specifically includes a Type subfield, an ID subfield, a Type Dependent Control subfield, and a plurality of information groups, where the Type subfield is used to indicate the type of the second frame, the ID subfield is set to 12 LSBs of the compressed MAC address of the AP MLD, the Type Dependent Control subfield is set to 12 MSBs of the compressed MAC address of the AP MLD, the plurality of information groups are used to indicate primary channel information of each BSS that is being advertised by the second frame, the primary channel information indicated by the plurality of information groups includes primary channel information of the first AP and the primary channel information of the at least one second AP, each of the plurality of information group includes a Link ID subfield and an Operating Class And Channel subfield, the Link ID subfield is used to indicate a link ID of a link for which a corresponding BSS is being advertised by the second frame, and the Operating Class And Channel subfield is used to indicate primary channel information of the corresponding BSS indicated by the Link ID subfield in a same information group.

In an embodiment of the second aspect or any one of the embodiments of the second aspect, the method further includes:
transmitting, by the AP MLD, a third frame through the first AP, where the third frame includes a compressed MAC address of the AP MLD and primary channel information of at least one second AP affiliated with the AP MLD, and a type of the third frame is different from that of a legacy WUR Discovery frame.

In an embodiment of the second aspect or any one of the embodiments of the second aspect, the first frame includes a WUR Discovery element, and the discovery information for the first AP is carried in the WUR Discovery element; or the first frame includes a WUR Discovery element and a RNR element, the WUR Discovery element and the RNR element include the information of the AP MLD, the RNR element includes a part of the discovery information for the first AP, and the WUR Discovery element does not include the part of the discovery information for the first AP.

According to a third aspect, provided is an apparatus that is configured to implement the methods provided by the above-mentioned aspects or their embodiments. Specifically, the apparatus may include units and/or modules, such as a processing unit and/or a communication unit, for the execution of any of the methods provided by the above-mentioned aspects or their embodiments.

In an embodiment of the third aspect, the apparatus is a station or an AP MLD. When the apparatus is a station or an AP MLD, the communication unit may be a transceiver, or an input/output interface, or a communication interface. The processing unit may be at least one processor. Optionally, the transceiver is a transmitting and receiving circuit. Optionally, the input/output interface is an input/output circuit.

In another embodiment of the third aspect, the apparatus is a chip, a system on a chip or a circuit in a station or an AP MLD. When the apparatus is a chip, a system on a chip or a circuit in the station or the AP MLD, the communication unit may be an input/output interface, an interface circuit, an output circuit, an input circuit, a pin or a related circuit on the chip, the system on a chip or the circuit. The processing unit may be at least one processor, processing circuit or logic circuit, etc.

According to a fourth aspect, provided is an apparatus, and the apparatus includes one or more processors, where the one or more processors are configured to execute a computer program stored in a memory to implement any of the methods provided by the above-mentioned aspects or their embodiments.

In an embodiment of the fourth aspect, the apparatus further includes the memory.

In an embodiment of the fourth aspect or any one of the embodiments of the fourth aspect, the apparatus is a station or an AP MLD.

In another embodiment of the fourth aspect or any one of the embodiments of the fourth aspect, the apparatus is a chip, a system on a chip or a circuit in a station or an AP MLD.

According to a fifth aspect, provided is an apparatus, and the apparatus includes at least one processor and a communication interface, where the at least one processor is used to obtain a computer program or instructions stored in a memory through the communication interface to implement any of the methods provided by the above-mentioned aspects or their embodiments. The communication interface can be implemented by hardware or software.

In an embodiment of the fifth aspect, the apparatus further includes the memory.

According to a sixth aspect, provided is a processor which is configured to execute a computer program stored in a memory to implement any of the methods provided by the above-mentioned aspects or their embodiments.

According to a seventh aspect, provided is a computer-readable medium on which a program is recorded, where the program, when executed, enables a computer to implement any of the methods provided by the above-mentioned aspects or their embodiments.

According to an eighth aspect, provided is a computer program product, where the computer program product includes instructions to implement any of the methods provided by the above-mentioned aspects or their embodiments.

According to a ninth aspect, provided is a computer program, where the computer program, when executed, enables a computer to implement any of the methods provided by the above-mentioned aspects or their embodiments.

According to a tenth aspect, provided is a chip, where the chip includes at least one processor and a communication interface, where the at least one processor is used to obtain a computer program or instructions stored in a memory through the communication interface to implement any of the methods provided by the above-mentioned aspects or their embodiments. The communication interface can be implemented by hardware or software.

In an embodiment of the tenth aspect, the chip further includes the memory.

When the method provided in this application is executed by a chip, this application does not limit the number of chips for implementing the method. For example, the method may be executed by one chip, or the method may be executed by two or more chips. In addition, when the number of chips is two or more, there is no limitation on the chip manufacturers, which can be the same manufacturer or different manufacturers.

According to an eleventh aspect, provided is a communication system, where the communication system includes the station and/or the AP MLD mentioned above.

### DESCRIPTION OF DRAWINGS

One or more embodiments are exemplarily described by corresponding accompanying drawings, and these exemplary illustrations and accompanying drawings constitute no limitation on the embodiments. Elements with the same reference numerals in the accompanying drawings are illustrated as similar elements, and the drawings are not limiting to scale, in which:

FIG. 1 is a schematic diagram of a communication system to which the embodiments of this application may be applied.

FIG. 2 is an exemplary architecture of a WUR AP MLD.

FIG. 3 is an exemplary architecture of a WUR non-AP MLD.

FIG. 4 is a schematic diagram of a communication method 400.

FIG. 5 is a format of a WUR Discovery element.

FIG. 6 is a format of a WUR AP Information subfield.

FIG. 7 is a format of a WUR AP Parameters subfield.

FIG. 8 is another format of a WUR AP Parameters subfield.

FIG. 9 is a format of a legacy WUR Discovery frame.

FIG. 10 is a format of a Frame Body field.

FIG. 11 is another exemplary format of a Frame Body field.

FIG. 12 is another exemplary format of a Frame Body field.

FIG. 13 is a schematic block diagram of an apparatus according to the present application.

FIG. 14 is a schematic block diagram of another apparatus according to the present application.

### DESCRIPTION OF EMBODIMENTS

In order to understand features and technical contents of embodiments of the present disclosure in detail, implementations of the embodiments of the present disclosure will be described in detail below with reference to the accompanying drawings, and the attached drawings are only for reference and illustration purposes, and are not intended to limit the embodiments of the present disclosure. In the following technical descriptions, for ease of explanation, numerous details are set forth to provide a thorough understanding of the disclosed embodiments. One or more embodiments, however, may be practiced without these details. In other cases, well-known structures and apparatuses may be shown simplified in order to simplify the drawings.

The embodiments of this application may be applied to a wireless local area network (WLAN) scenario. In an example, the embodiments of this application may be applied to the IEEE Std 802.11, such as Std 802.11a/b/g, 802.11n, 802.11ac, 802.11ax, 802.11ba, 802.11be, Wi-Fi 7, EHT, Wi-Fi 8, UHR (ultra-high reliability), Wi-Fi AI or their next generation standards. In another example, the embodiments of this application may be applied to an ultra-wide bandwidth (UWB) based wireless personal local area network system, or a sensing system.

Although this application mainly describes the deployment of a WLAN network, especially the network applying IEEE Std 802.11 as an example, it is easy for technical person in this field to understand that the embodiments of this application can be extended to other networks or communication systems using a variety of standards or protocols, such as Bluetooth, a high performance radio local area network (HIPERLAN), a wide area network (WAN), a personal area network (PAN), a cellular network, new radio (NR) or any other network that is known currently or developed later. Therefore, the embodiments of this application can be applied to any suitable wireless network, regardless of the coverage and wireless access protocol.

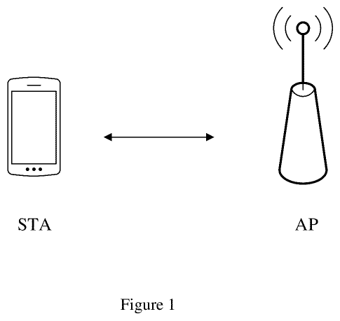

In an example, FIG. 1 is a schematic diagram of a communication system to which the embodiments of this application may be applied. The communication system may include one or more APs and one or more stations (STA), and FIG. 1 illustrates the communication between one AP and one STA as an example. The AP and the STA may communicate wirelessly through various standards.

The AP may be a communication server, router, switch, enterprise AP or another terminal, and the STA may be a mobile phone, computer, or another terminal. This is not limited in the embodiments of this application.

The AP may be the access point for terminals (such as mobile phones) to access the wired (or wireless) network. It is mainly deployed in homes, buildings and work parks with a coverage radius of tens to hundreds of meters. Of course, it can also be deployed outdoors. It connects wireless clients together and then connects the wireless network to the Ethernet. For example, the AP may be a terminal with a Wi-Fi chip (such as a cell phone) or a network device (such as a router). The AP may be a device that supports IEEE Std 802.11. The AP can also be a device that supports various WLAN standards of the 802.11 family, such as 802.11ax, 802.11ac, 802.11n, 802.11g, 802.11b, 802.11a, 802.11ba, 802.11be or their next generation standards. The AP may be a HE AP or an EHT AP, or an AP applicable to a future Wi-Fi standard.

The STA may be a wireless communication chip, wireless sensor or wireless communication terminal. For example, the STA may be a mobile phone, tablet, set-top box, smart TV, smart wearable device, Vehicle communication equipment or computer, which supports Wi-Fi communication. The STA may be a device that supports IEEE Std 802.11. The STA can also be a device that supports various WLAN standards of the 802.11 family, such as 802.11ax, 802.11ac, 802.11n, 802.11g, 802.11b, 802.11a, 802.11ba, 802.11be or their next generation standards.

For example, the AP or the STA may be a device applied to a vehicle-to-everything (V2X) scenario, may be a node or sensor applied to Internet of Things (IoT) scenario, may be a sensor applied to a smart city scenario, or may be a smart camera, smart water meter, smart remote control or electricity meter applied to a smart home scenario.

Embodiments of the present application relate to a MLD. The MLD is a device that has multiple radio frequency (RF) modules. The multiple RF modules may respectively work in different frequency bands (or channels). The MLD may be a wireless communication device that supports parallel transmission of multiple links. The MLD has higher transmission efficiency and throughput than the device that supports only single link.

The MLD includes one or more affiliated STAs. Each of the one or more affiliated STAs is a station that has its own MAC address and can work on one link. The MLD also has an MLD MAC address. An affiliated STA may be an AP or a non-AP STA. In this application, for convenience of description, an MLD with which one or more APs are affiliated may be referred to as an AP MLD, and an MLD with which one or more STAs are affiliated may be referred to as a non-AP MLD.

A WUR non-AP MLD is a non-AP MLD that is capable of receiving WUR PPDUs using a single wake-up radio and supports the enhanced WUR operation; and a WUR AP MLD is an AP MLD that is capable of transmitting WUR PPDUs and supports the enhanced WUR operation. The enhanced WUR operation is defined at an MLD level instead of a link level.

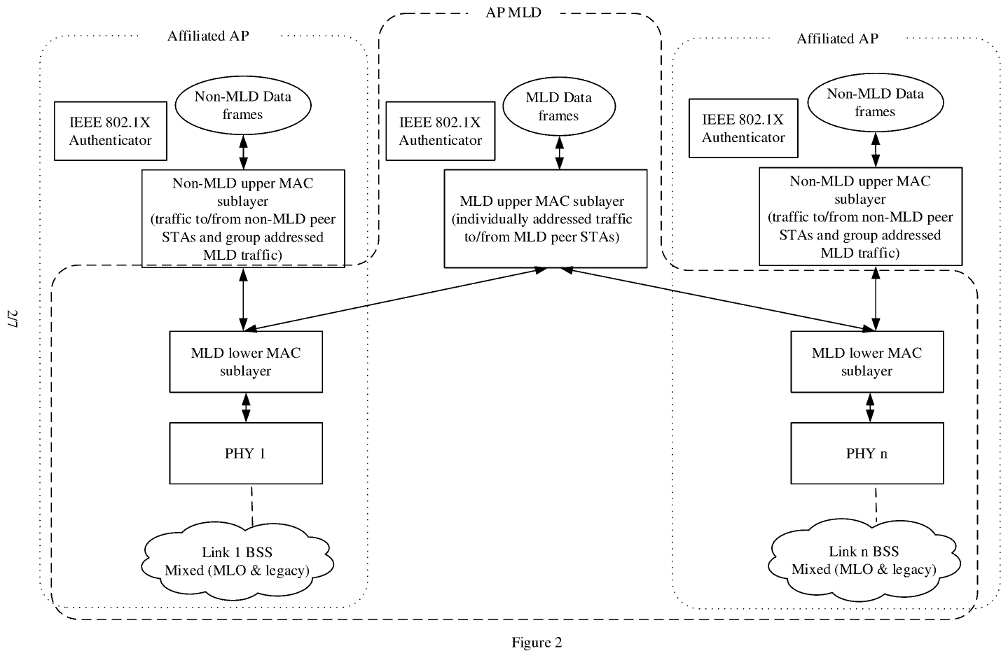

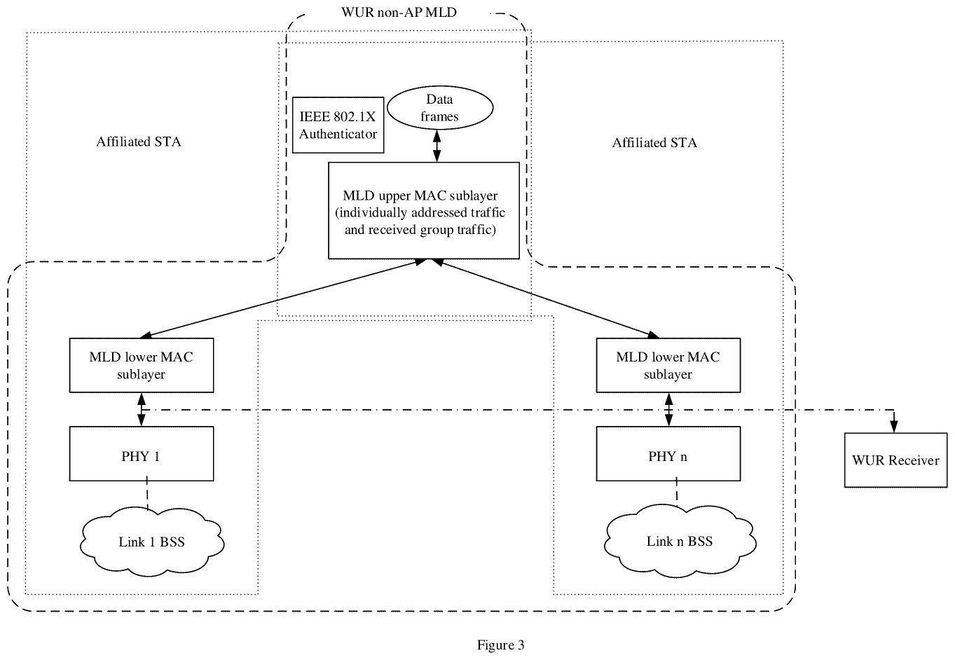

An exemplary architecture of a WUR AP MLD is shown in FIG. 2. The WUR AP MLD always operates in cooperation with one or more affiliated APs, one for each link. MLD lower MAC sublayer components implement link specific functions that operate independently of the lower MAC in other affiliated APs, and are shared between each affiliated AP and the AP MLD operations. At least one of physical layers (PHYs) corresponding to a WUR channel is able to transmit WUR PPDUs, and an MLD upper MAC sublayer and at least one of MLD lower MAC sublayers corresponding to the WUR channel are able to support an enhanced WUR operation. An exemplary architecture of a WUR non-AP MLD is shown in FIG. 3, which includes an MLD upper MAC sublayer and MLD lower MAC sublayers (one for each link). The single upper MAC sublayer within the WUR non-AP MLD can operate at any given time in an MLO over multiple MLD lower MAC sublayers and PHY pairs for association to a WUR AP MLD. A WUR receiver is able to receive WUR PPDUs on one of links corresponding to a WUR channel, and the MLD upper MAC sublayer and at least one of the MLD lower MAC sublayers corresponding to the WUR channel are able to support an enhanced WUR operation.

As described in the background part above, the current discovery mechanism is designed to assist in discovery of an AP which is based on a single link operation. As a result, the current discovery mechanism cannot be directly applicable to discovery of a WUR AP MLD which is based on an MLO. Therefore, how to enhance the discovery mechanism for AP MLD discovery is a challenge.

To solve the problem above, embodiments of the present application provide a communication method and a communication apparatus, which are helpful to discover an AP MLD. The following describes the proposed solution of the present application in more retail.

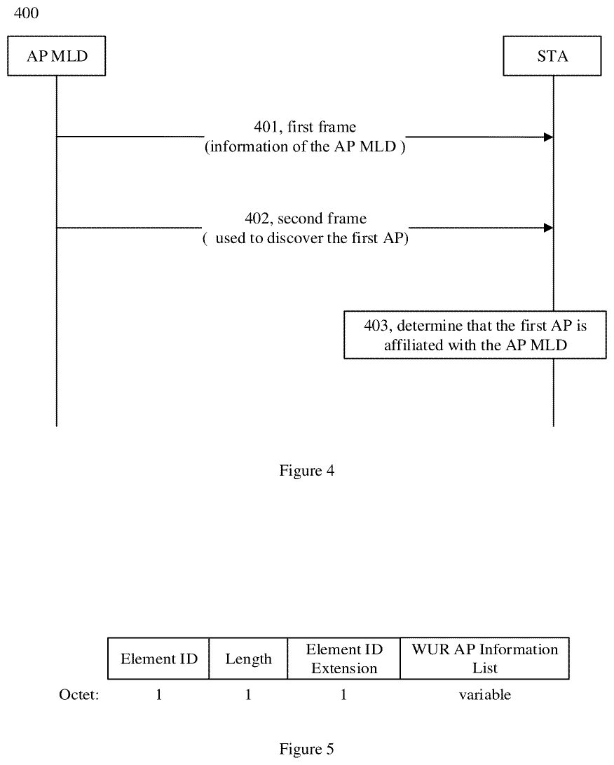

FIG. 4 is a schematic diagram of a communication method 400. The method 400 may be performed by an AP MLD and a STA, or by modules or units in an AP MLD and a STA, and for convenience of description, hereinafter they are referred to as an AP MLD and a STA. The method 400 specifically includes the following steps.

Step 401: an AP MLD transmits a first frame through a first AP affiliated with the AP MLD, and accordingly, a STA receives the first frame from the first AP.

The first AP may be any of the APs affiliated with the AP MLD, and hereinafter, the first AP is used as an example. The STA may be a non-AP STA. It should be noted that in the WUR scenario, the AP, AP MLD and STA may be respectively referred to as a WUR AP, WUR AP MLD and WUR non-AP STA.

The first frame may include discovery information for the first AP, and the discovery information for the first AP includes information of the AP MLD. In a possible implementation, the information of the AP MLD includes at least one of the following parameters: an AP MLD ID of the AP MLD, a link ID of the first AP within the AP MLD or a MAC address of the AP MLD.

The discovery information for the first AP may also include other regular discovery information for the first AP, such as a discovery channel and a discovery period.

It should be mentioned that, the method 400 only takes the first frame sent by the first AP as an example. The first frame may be sent by the first AP or another AP. For example, another AP may be an AP affiliated with the AP MLD as the first AP, a neighboring AP or an AP affiliated with a neighboring AP MLD.

Step 402: the AP MLD transmits a second frame through the first AP affiliated with the AP MLD, and accordingly, the STA receives the second frame from the first AP.

The second frame is used to discover the first AP. The second frame carries essential information of the first AP, such as primary channel information of the first AP.

The second frame may be a discovery frame. This application does not limit the format of the discovery frame.

Step 403: the STA determines that the first AP is affiliated with the AP MLD according to the discovery information for the first AP and the second frame.

The STA may determine the discovery information for the first AP according to information included in the second frame and associated with the discovery information for the first AP, and then determine that the first AP is affiliated with the AP MLD according the information of the AP MLD in the discovery information for the first AP. The information associated with the discovery information for the first AP, for example, may include at least one of the following parameters: a compressed basic service set identifier (BSSID) of the first AP, a compressed short SSID of the first AP, or a compressed MAC address of the AP MLD.

According to the method 400, the discovery information for the first AP affiliated with the AP MLD includes the information of the AP MILD. In this way, when the STA discovers the first AP, that is, the STA receives the second frame sent by the first AP, the STA is able to use the information of the AP MLD in the discovery information for the first AP to determine that the first AP is affiliated with the AP MLD. Thus, the STA is able to discover an AP and determine an AP MLD with which the AP is affiliated, and then realize the discovery of the AP MHLD.

Embodiments of the method 400 will be described in detail below.

Regarding the first frame, in a possible implementation, the first frame further includes discovery information for at least one second AP and/or discovery information for at least one third AP, where each second AP is an AP affiliated with the AP MLD, discovery information for each second AP includes the information of the AP MLD, each third AP is an AP affiliated with a neighboring AP MLD of the AP MLD, and discovery information for each third AP includes information of an AP MLD with which the third AP is affiliated. The discovery information for each second AP and/or each third AP may also include other regular discovery information, such as a discovery channel and a discovery period.

In another possible implementation, the first frame further includes discovery information for at least one fourth AP, where each fourth AP is a neighboring AP of the first AP, and discovery information for each fourth AP includes information of the fourth AP. The discovery information for each fourth AP may include regular discovery information, such as a discovery channel and a discovery period.

In another possible implementation, the first frame may be a Beacon frame or a Probe Response frame. In an example, the discovery information for each of the first AP, the at least one second AP, the at least one third AP or the at least one fourth AP may be carried in a discovery element, such as a WUR Discovery element. In other words, the first frame includes a discovery element, and the discovery information for the first AP is carried in the discovery element.

In the WUR scenario, an AP, AP MLD and discovery element may be respectively referred to as a WUR AP, WUR AP MLD and WUR Discovery element. Several examples of the WUR Discovery element are given below.

### Example 1

The format of the WUR Discovery element is illustrated in FIG. 5. The WUR Discovery element includes an Element ID field, a Length field, an Element ID Extension field, and a WUR AP Information List field. The Element ID field, Length field and Element ID Extension field are defined as in the IEEE Std 802.11ba™-2021. The WUR AP Information List field further includes one or more WUR AP Information subfields. Each WUR AP Information subfield identifies the WUR APs that transmit legacy WUR Discovery frames on a particular WUR discovery channel.

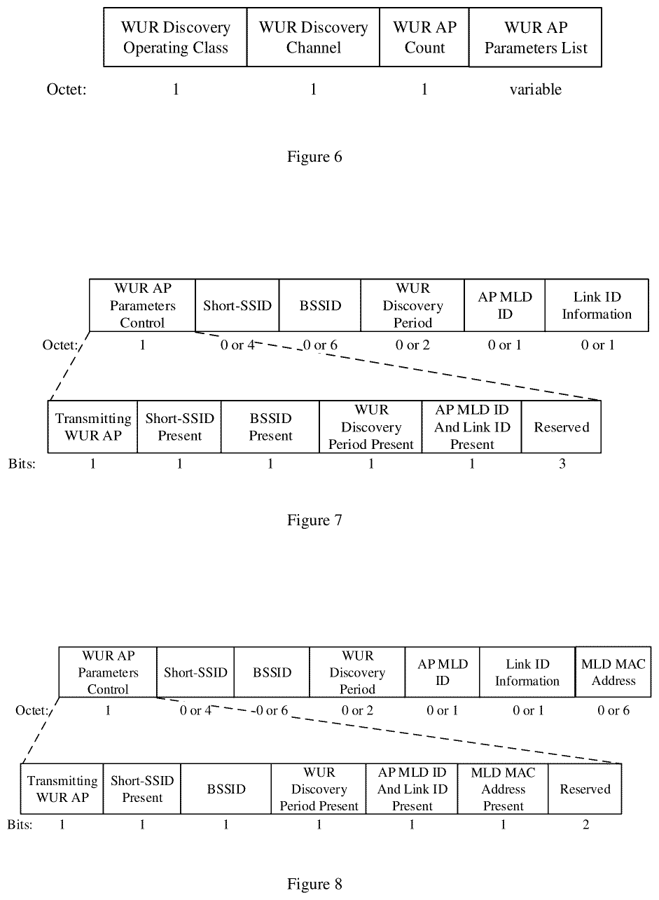

The format of the WUR AP Information subfield is illustrated in FIG. 6. A WUR Discovery Operating Class field indicates the operating class in use for transmission of legacy WUR Discovery frames by WUR APs listed in this subfield. A WUR Discovery Channel field indicates the channel in use for transmission of legacy WUR Discovery frames by WUR APs listed in this subfield. A WUR AP Count field specifies the number of WUR AP Parameters subfields that are included in a WUR AP Parameters List field, minus one. The WUR AP Parameters List field contains one or more WUR AP Parameters subfields. Each WUR AP Parameters subfield identifies one WUR AP, which may be the WUR AP transmitting this WUR Discovery element itself (i.e. a transmitting WUR AP), a WUR AP affiliated with the same WUR AP MLD as the transmitting WUR AP, or a neighboring WUR AP, or a WUR AP which is affiliated with a neighboring WUR AP MLD. In the method 400, the transmitting WUR AP is the first AP.

The format of the WUR AP Parameters subfield is shown in FIG. 7. A WUR AP Parameters Control field indicates the presence of a Short-SSID field, a BSSID field, a WUR Discovery Period field, an AP MLD ID field and a Link ID Information field. A Transmitting WUR AP subfield is set to 1 if the WUR AP Parameters subfield identifies the transmitting WUR AP's own WUR discovery channel and is set to 0, otherwise. A Short-SSID Present subfield is set to 1 if the Short-SSID field is present in the WUR AP Parameters subfield and is set to 0, otherwise. A BSSID Present subfield is set to 1 if the BSSID field is present in the WUR AP Parameters subfield and is set to 0, otherwise. A WUR Discovery Period Present subfield is set to 1 if the WUR Discovery Period field is present in the WUR AP Parameters subfield and is set to 0, otherwise. An AP MLD ID And Link ID Present subfield is set to 1 if both the AP MLD ID field and the Link ID Information field are present in the WUR AP Parameters subfield and is set to 0, otherwise. The AP MLD ID And Link ID Present subfield shall be set to 0 if the WUR AP identified by the WUR AP Parameters subfield is not a part of a WUR AP MLD, or if the transmitting WUR AP does not have information of that WUR AP MLD.

The Short-SSID field contains a short SSID of the WUR AP identified by the WUR AP Parameters subfield. The BSSID field contains a BSSID of the WUR AP identified by the WUR AP Parameters subfield. The WUR Discovery Period field contains the number of time units (TUs) between consecutive legacy WUR Discovery frames transmitted by the WUR AP identified by the WUR AP Parameters subfield. 0 is reserved.

The AP MLD ID field indicates the identifier of the AP MLD with which the WUR AP identified by the WUR AP Parameters subfield is affiliated. If the WUR AP identified by the WUR AP Parameters subfield is affiliated with the same MLD as the transmitting WUR AP, the AP MLD ID field is set to 0. If the WUR AP identified by the WUR AP Parameters subfield is affiliated with an AP MLD that is not the AP MLD with which the transmitting WUR AP is affiliated, the AP MLD ID subfield is set to a value that is unique for this AP MLD in the frame carrying this element and that is higher than 0 and lower than 255 if no Multiple BSSID element is carried in the same frame or a value higher than 2ⁿ-1 and lower than 255 if a Multiple BSSID element is carried in the same frame, where n is the value contained in a MaxBSSID Indicator field in the Multiple BSSID element. The Link ID Information field includes a 4-bit Link ID subfield which indicates the link identifier of the WUR AP identified by the WUR AP Parameters subfield within its affiliated AP MLD.

### Example 2

Example 2 is similar to Example 1. The difference is that the WUR AP Parameters subfield of the WUR AP identified by the WUR AP Parameters subfield includes an MLD MAC Address field indicating the MLD MAC address of the WUR AP MLD with which the WUR AP is affiliated.

Specially, the format of the WUR Discovery element and the WUR AP Information subfield may refer to the description of FIG. 6 and FIG. 7 in Example 1, and will not be repeated here.

The format of the WUR AP Parameters subfield is shown in FIG. 8. The WUR AP Parameters Control field indicates the presence of a Short-SSID field, a BSSID field, a WUR Discovery Period field, an AP MLD ID field, a Link ID Information field and an MLD MAC Address field. A MLD MAC Address Present subfield is set to 1 if the MLD MAC Address field is present in the WUR AP Parameters subfield and is set to 0, otherwise. The MLD MAC Address Present subfield shall be set to 0 when an AP MLD ID And Link ID Present subfield is set to 0. The MLD MAC Address field indicates the MLD MAC address of the WUR AP MLD with which the WUR AP identified by the WUR AP Parameters subfield is affiliated. The description of the rest fields of the WUR AP Parameters subfield may refer to FIG. 7 in Example 1, and will not be repeated here.

Thus, an AP affiliated with a WUR AP MLD may transmit a discovery element in a Beacon frame and/or Probe Response frame to indicate discovery information for one or more WUR APs, each of which may be a transmitting WUR AP, a WUR AP affiliated with the same WUR AP MLD as the transmitting AP, a neighboring AP or a WUR AP affiliated with a neighboring WUR AP MLD.

In another possible implementation, a part of the discovery information for each of the first AP, the at least one second AP, the at least one third AP or the at least one fourth AP may be carried in a discovery element, such as a WUR Discovery element, and the rest part of the discovery information for each of the first AP, the at least one second AP, the at least one third AP or the at least one fourth AP may be carried in an RAN element. In other words, the first frame includes a discovery element and an RNR element, the discovery element and the RNR element include same information of the AP MLD, and the discovery element does not include a part of the discovery information while the RNR element includes the part of the discovery information. A more detailed description is as below.

Let us take an AP MLD ID and a Link ID as the information of the AP MLD. If the discovery information for an AP affiliated with an AP MLD is included in a discovery element in a Beacon frame and/or Probe Response frame, the regular discovery information for this AP shall be included in an RNR element in the same frame. For a same AP affiliated with a same AP MLD, the AP MLD ID and Link ID subfields of the AP parameters field in the discovery element shall be set to the same values as their respective counterparts of the target beacon transmission time (TBTT) information field in the RNR element. As a result, for an AP affiliated with an AP MLD, its discovery information included in the discovery element and its regular discovery information included in the RNR element in the same frame can be associated via the AP MLD ID and Link ID subfields. Such an association between the discovery element and the RNR element can be utilized to minimize the overhead. For example, for a WUR AP affiliated with an WUR AP MLD, since the information such as a BSSID and a short SSID has been already included in a TBTT information field of the RNR element, it may not be required in the corresponding WUR AP Parameters field of the WUR Discovery element.

In addition, when a Disabled Link Indication subfield of a TBTT Information field in the RNR element included in a Beacon frame and/or Probe Response frame indicates a disabled link of a WUR AP MLD, the WUR Discovery element in the same frame shall not include a WUR AP Parameters field for the WUR AP operating on that link of the WUR AP MLD.

For step 402, the second frame may be a discovery frame. This application does not limit the format of the discovery frame. In the WUR scenario, an AP, an AP MLD and a discovery frame may be respectively referred to as a WUR AP, a WUR AP MLD and a WUR Discovery frame. Several examples of the WUR Discovery frame are given below.

### Example 1

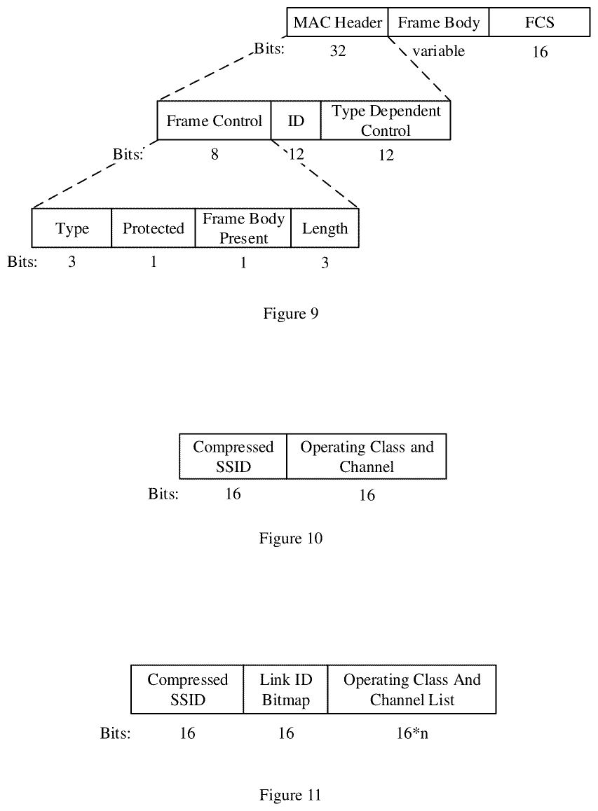

The WUR Discovery frame is a legacy WUR Discovery frame defined as that in the IEEE Std 802.11ba™-2021, and its format is shown in FIG. 9. A MAC Header field includes a Frame Control subfield, an ID subfield and a Type Dependent Control subfield. The Frame Control subfield includes a Type subfield, a Protected subfield, a Frame Body Present subfield and a Length subfield. The Type subfield is set to a value (e.g., 3) to indicate that the frame is a legacy WUR Discovery frame. The Protected subfield is set to a value (e.g., 0) to indicate that the legacy WUR Discovery frame contains the 16-bit cyclic redundancy check (CRC). The Frame Body Present subfield is set to a value (e.g., 1) to indicate that a Frame Body field is present in this frame. The Length subfield is set to indicate that the Frame Body field is 4 octets in length. The ID subfield is set to a transmitter ID, which is 12 LSBs of the compressed BSSID of the transmitting AP. The Type Dependent Control subfield is set to 12 MSBs of the compressed BSSID of the transmitting AP. In the method 400, the transmitting AP is the first AP.

The format of the Frame Body field is shown in FIG. 10. A Compressed SSID field contains 16 LSBs of the short SSID and the Operating Class And Channel subfield indicates the location of the primary channel of the BSS being advertised by the legacy WUR Discovery frame.

In a possible implementation, when the second frame in step 402 is a legacy WUR Discovery frame as defined in FIG. 9 and FIG. 10, to obtain essential information of the WUR AP MLD, the AP MLD may further transmit legacy WUR Discovery frames through the rest APs affiliated with the AP MLD, and accordingly, the STA may further receive the legacy WUR Discovery frames from the rest APs. In this implementation, each AP affiliated with a WUR AP MLD periodically schedules its own legacy WUR Discovery frames for transmission on its own WUR discovery channel to assist STAs in WUR AP MLD discovery.

When the second frame in step 402 is a legacy WUR Discovery frame, the behavior of the STA in step 402 will be described in detail below.

In a possible implementation, the STA may generate a request primitive on an SME, perform scanning according to the parameters given in the request primitive to receive the second frame on a MAC layer. In an example, the request primitive may include the following parameters:
1) a WURDiscoveryChannelList: indicating one or more WUR discovery channels to be scanned;
2) a Transmitter ID (optional): indicating a transmitter ID of an WUR AP to be discovered;
3) a CompressedBSSID_MSB (optional): indicating 12 MSBs of a compressed BSSID of the WUR AP to be discovered; and
4) a Compressed SSID (optional): indicating 16 LSBs of a short SSID of the WUR AP to be discovered.

When the STA has completed scanning for all indicated WUR discovery channels, it returns the scan results in one or more parameter sets of a confirm primitive to the SME based on the second frame on the MAC layer. Each parameter set is specific to a discovered WUR AP and includes the following parameters:
1) a Transmitter ID: indicating a transmitter ID of a discovered WUR AP;
2) a CompressedBSSID_MSB: indicating 12 MSBs of a compressed BSSID of the discovered WUR AP;
3) a Compressed SSID: indicating 16 LSBs of a short SSID of the discovered WUR AP;
4) an Operating Channel: specifying a primary channel of the discovered WUR AP; and
5) a RSSI: specifying a RSSI from the discovered WUR AP.

Optionally, the request primitive is a HLME-WURDISCOVERYrequest primitive, and/or the confirm primitive is a MLME-WURDISCOVERYconfirm primitive. The parameter set may be a BSSDescriptionFromWDSet parameter set.

Thus, according to the information for each AP affiliated with a WUR AP MLD such as an SSID and a BSSID in the most recently received discovery element and/or RNR element, the STA is able to determine one or more BSSDescriptionFromWDSet parameter sets corresponding to APs affiliated with a same WUR AP MLD.

### Example 2

The WUR Discovery frame is an enhanced WUR Discovery frame which may carry essential information of one or more APs affiliated with the WUR AP MLD.

Specially, when both a legacy WUR Discovery frame and an enhanced WUR Discovery frame are transmitted by an AP affiliated with a WUR AP MLD in a same transmission opportunity (TXOP) or different TXOPs within a WUR discovery period,
Option 1: the enhanced WUR Discovery frame carries essential information of all APs affiliated with the WUR AP MLD, and in this case, the WUR non-AP STAs may ignore the reception of the legacy WUR Discovery frame; or
Option 2: the enhanced WUR Discovery frame carries essential information of all APs affiliated with the WUR AP MLD except the transmitting AP, and in this case, the WUR non-AP STAs need to receive both the legacy and enhanced WUR Discovery frames.

The format of the enhanced WUR Discovery frame will be described next.

An exemplary format of the enhanced WUR Discovery frame can refer to FIG. 9, but the meaning of each of the fields of the enhanced WUR Discovery frame is as follows.

The Type subfield of the MAC Header field is set to a value (e.g., 5) to indicate that the frame is an enhanced WUR Discovery frame. The Protected subfield is set to a value (e.g., 0) to indicate that the enhanced WUR Discovery frame contains the 16-bit CRC. The Frame Body Present subfield is set to a value (e.g., 1) to indicate that the Frame Body field is present in this frame. The Length subfield is set to indicate a length of the Frame Body field. The ID subfield is set to a transmitter ID, which is 12 LSBs of the compressed MLD MAC address of the WUR AP MLD with which the transmitting WUR AP is affiliated. The Type Dependent Control subfield is set to 12 MSBs of the compressed MLD MAC address of the WUR AP MLD with which the transmitting WUR AP is affiliated.

The Frame Body field of the enhanced WUR Discovery frame is different from that of the legacy WUR Discovery frame.

An exemplary format of the Frame Body field is defined in FIG. 11. A Compressed SSID field contains 16 LSBs of a short SSID. A Link ID Bitmap subfield indicates a link ID of each link for which a corresponding BSS is being advertised by the enhanced WUR Discovery frame. A value of 1 at bit position k in the bitmap indicates that the BSS corresponding to link k is advertised by the enhanced WUR Discovery frame. A value of 0 at bit position k in the bitmap indicates that the BSS corresponding to link k is not advertised by the enhanced WUR Discovery frame. An Operating Class And Channel List subfield includes one or more Operating Class And Channel subfields, each of which indicates the location of a primary channel of a BSS corresponding to a particular link with a corresponding bit in the Link ID Bitmap subfield set to 1. The one or more Operating Class And Channel subfields are sequenced in the increasing order in terms of link IDs. For example, if a WUR AP MLD has three links (i.e. link 1, link 2 and link 3) and the Link ID Bitmap subfield indicates that the BSSs corresponding to link 1 and link 3 are advertised by the enhanced WUR Discovery frame, there are two Operating Class And Channel subfields for link 1 and link 3. The first Operating Class And Channel subfield corresponds to link 1, and the second Operating Class And Channel subfield corresponds to link 3.

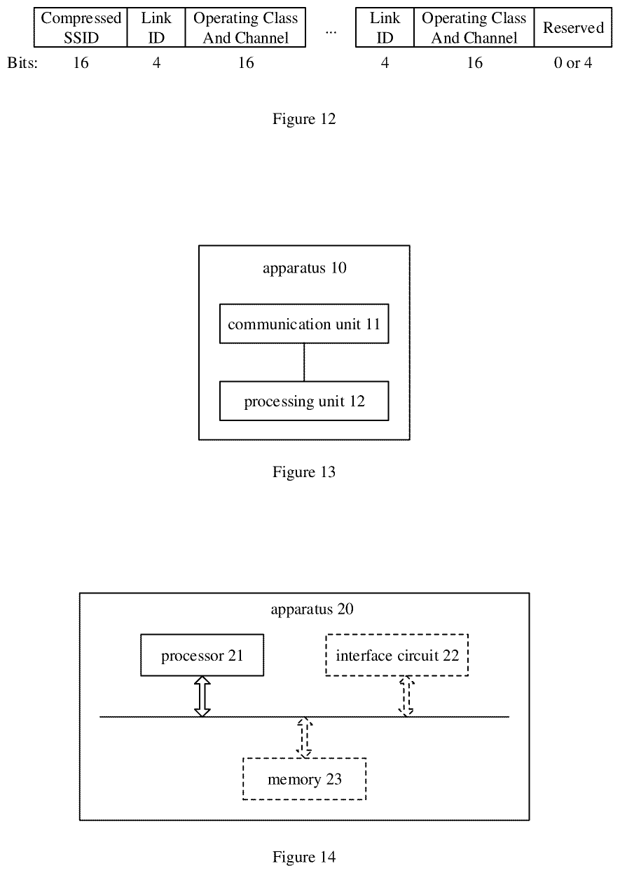

Another exemplary format of the Frame Body field is defined in FIG. 12. For each BSS advertised by the enhanced WUR Discovery frame, there is a Link ID subfield and an Operating Class And Channel subfield. The Operating Class And Channel subfield indicates the location of a primary channel of a BSS corresponding to a link indicated in the preceding Link ID subfield.

As stated in Example 2, the ID subfield is set to 12 LSBs of the compressed MLD MAC address of the WUR AP MLD with which the transmitting WUR AP is affiliated, and the Frame Body field carries essential information of one or more APs affiliated with the WUR AP MLD. Thus, it could also be regarded as discovering the AP MLD.

In a possible implementation, when the second frame in step 402 is a legacy WUR Discovery frame as defined in FIG. 9 and FIG. 10, to obtain essential information of the WUR AP MLD, the AP MLD may further transmit a third frame which is an enhanced WUR Discovery frame through the first AP, and accordingly, the STA may further receive the third frame from the first AP. In this case, the third frame may include essential information (e.g., primary channel information) of at least one second AP. The at least one second AP belongs to the APs affiliated with the WUR AP MLD except the transmitting AP (i.e. the first AP). In other words, the third frame may carry essential information of all APs affiliated with the WUR AP MLD except the transmitting AP (i.e. the first AP).

In this implementation, one or more WUR discovery channels may be configured per WUR AP MLD. Each AP affiliated with a WUR AP MLD that is operating on any of the one or more WUR discovery channels periodically schedules legacy WUR Discovery frames and enhanced WUR Discovery frames for transmission to assist WUR non-AP STAs in WUR AP MLD discovery. Thus, the STA may perform WUR scanning on a single WUR discovery channel per WUR AP MLD. Since the STA is able to obtain essential information of a WUR AP MLD by scanning a single WUR discovery channel, WUR scanning latency and power consumption can be significantly reduced.

In another possible implementation, when the second frame in step 402 is an enhanced WUR Discovery frame as defined in Example 2, in other words, the second frame further carries essential information (e.g., primary channel information) of at least one second AP affiliated with the WUR AP MLD. The at least one second AP belongs to the APs affiliated with the WUR AP MLD except the transmitting AP (i.e. the first AP).

In an example, in the second frame, the Type subfield is used to indicate the enhanced WUR Discovery frame. The Link ID Bitmap subfield is used to indicate a link ID of each link for which a corresponding BSS is being advertised by the second frame, and Link IDs indicated by the Link ID Bitmap subfield include a link ID of the first AP and a link ID of the at least one second AP. The Operating Class And Channel List subfield is used to indicate primary channel information of each BSS that is being advertised by the second frame, and the primary channel information indicated by the Operating Class And Channel List subfield includes primary channel information of the first AP and primary channel information of the at least one second AP.

In another example, the second frame specifically includes a Type subfield and a plurality of information groups, where each of the plurality of information groups includes a Link ID subfield and an Operating Class And Channel subfield. The type subfield is used to indicate the enhanced WUR Discovery frame. The plurality of information groups are used to indicate primary channel information of each BSS that is being advertised by the second frame, and the primary channel information indicated by the plurality of information groups includes primary channel information of the first AP and primary channel information of the at least one second AP.

In this implementation, one or more WUR discovery channels may be configured per WUR AP MLD. Each AP affiliated with a WUR AP MLD that is operating on any of the one or more WUR discovery channels periodically schedules enhanced WUR Discovery frames for transmission to assist STAs in WUR AP MLD discovery. Thus, the STA may perform WUR scanning on a single WUR discovery channel per WUR AP MLD. Since the STA is able to obtain essential information of a WUR AP MLD by scanning a single WUR discovery channel, WUR scanning latency and power consumption can be significantly reduced. Of course, a legacy WUR Discovery frame may also be scheduled by the first AP, but the STA may ignore the reception of the legacy WUR Discovery frame as explained in Option 1 above.

When the second frame in step 402 is an enhanced WUR Discovery frame, it should be noted that if an AP is affiliated with an AP MLD, the discovery information of the AP in the first frame should include an MLD MAC Address field indicating the MLD MAC address of the WUR AP MLD with which the AP is affiliated. The behavior of the STA will be described in detail below.

In a possible implementation, the STA may generate a request primitive on an SME, perform scanning according to the parameters given in the request primitive to receive the second frame on a MAC layer. In an example, the request primitive may include the following parameters:
1) a WURDiscoveryChannelList: indicating one or more WUR discovery channels to be scanned;
2) an AP MLD Indicator (optional): setting to 0 to indicate that a WUR AP is to be discovered; or setting to 1 to indicate that a WUR AP MLD is to be discovered;
3) a Transmitter ID (optional): indicating a Transmitter ID of the WUR AP to be discovered if the AP MLD Indicator has a value of 0; or a Transmitter ID of the WUR AP MLD to be discovered if the AP MLD Indicator has a value of 1;
4) a CompressedMLDMACAddress_MSB (optional): indicating 12 MSBs of a compressed MLD MAC address of the WUR AP MLD to be discovered; or it is not present if the AP MLD Indicator has a value of 0;
5) a CompressedBSSID_MSB (optional): indicating 12 MSBs of a compressed BSSID of the WUR AP to be discovered; or it is not present if the AP MLD Indicator has a value of 1; and
6) a Compressed SSID (optional): indicating 16 LSBs of a short SSID of the WUR AP or the WUR AP MLD to be discovered.

When the STA has completed scanning for all indicated WUR discovery channels, it returns the scan results in one or more parameter sets of a confirm primitive to the SME based on the second frame on the MAC layer. Each parameter set is specific to a discovered WUR AP or a discovered WUR AP MLD and includes the following parameters:
1) an AP MLD Indicator: setting to 0 to indicate that a WUR AP is discovered; or setting to 1 to indicate that a WUR AP MLD is discovered;
2) a Transmitter ID: indicating a transmitter ID of the discovered WUR AP if the AP MLD Indicator has a value of 0; or a transmitter ID of the discovered WUR AP MLD if the AP MLD Indicator has a value of 1;
3) a CompressedBSSID_MSB: indicating 12 MSBs of a compressed BSSID of the discovered WUR AP if the AP MLD Indicator has a value of 0; otherwise it is not present;
4) a CompressedMLDMACAddress_MSB: indicating 12 MSBs of a compressed MLD MAC address of the discovered WUR AP MLD if the AP MLD Indicator has a value of 1; otherwise it is not present;
5) a Compressed SSID: indicating 16 LSBs of a short SSID of the discovered WUR AP or the discovered WUR AP MLD;
6) a Link ID Bitmap or LinkIDList: specifying one or more APs affiliated with the discovered WUR AP MLD if the AP MLD Indicator has a value of 1; otherwise it is not present;
7) an OperatingChannelList: specifying a primary channel of the discovered WUR AP if the AP MLD Indicator has a value of 0 or a primary channel of each of one or more APs affiliated with the discovered WUR AP MLD if the AP MLD Indicator has a value of 1; and
8) a RSSI: specifying a RSSI from the discovered WUR AP if the AP MLD Indicator has a value of 0 or the transmitting AP affiliated with the discovered WUR AP MLD if the AP MLD Indicator has a value of 1.

Optionally, the request primitive is a MLME-WURDISCOVERY.request primitive, and/or the confirm primitive is a MLME-WURDISCOVERYconfirm primitive. The parameter set may be a BSSDescriptionFromWDSet parameter set.

In the present application, the discovery mechanism is enhanced to enable more efficient AP MLD discovery and keep backward compatibility with legacy STAs.

It should be noted that the above embodiments of this application may be implemented independently or together in an appropriate way.

The method provided in this application is described in detail above in conjunction with FIGS. 4 to 12. The apparatus embodiments of this application will be described in detail below in conjunction with FIGS. 13 to 14.

It is understood that in order to implement the functions in the above embodiments, the apparatus in FIG. 13 or FIG. 14 may include the corresponding hardware architecture and/or software modules that perform each of the functions.

FIG. 19 and FIG. 20 provide possible structural diagrams of the apparatus. The apparatus may be used to implement the functions of the AP MLD or the STA of the method embodiments described above, and thus the apparatus is able to achieve the beneficial effects of the method embodiments described above.

As shown in FIG. 13, an apparatus 10 includes a communication unit 11 and a processing unit 12.

When the apparatus 10 is used to implement the functions of the STA in the method embodiments described above, the communication unit 11 is used for receiving a first frame, where the first frame includes discovery information for a first AP affiliated with an AP MLD, and the discovery information for the first AP includes information of the AP MLD; and receiving a second frame from the first AP, where the second frame is used to discover the first AP. The processing unit 12 is used for determining that the first AP is affiliated with the AP MLD according to the discovery information for the first AP and the second frame.

Optionally, the information of the AP MLD includes at least one of the following parameters: an AP MLD ID of the AP MLD, a link ID of the first AP within the AP MLD or a MAC address of the AP MLD.

Optionally, the first frame further includes discovery information for at least one second AP and/or discovery information for at least one third AP, where each second AP is an AP affiliated with the AP MLD, discovery information for each second AP includes the information of the AP MLD, each third AP is an AP affiliated with a neighboring AP MLD of the AP MLD, and discovery information for each third AP includes an information of an AP MLD with which the third AP is affiliated.

Optionally, the first frame further includes discovery information for at least one fourth AP, where each fourth AP is a neighboring AP of the first AP, and discovery information for each fourth AP includes information of the fourth AP.

Optionally, the type of the second frame is different from that of a legacy WUR Discovery frame, and the second frame includes a compressed MAC address of the AP MLD and primary channel information of at least one second AP affiliated with the AP MLD.

Optionally, the second frame specifically includes a Type subfield, an ID subfield, a Type Dependent Control subfield, a Link ID Bitmap subfield and an Operating Class And Channel List subfield, where the Type subfield is used to indicate the type of the second frame, the ID subfield is set to 12 LSBs of the compressed MAC address of the AP MLD, the Type Dependent Control subfield is set to 12 MSBs of the compressed MAC address of the AP MLD, the Link ID Bitmap subfield is used to indicate a link ID of each link for which a corresponding BSS is being advertised by the second frame, link IDs indicated by the Link ID Bitmap subfield include a link ID of the first AP and a link ID of the at least one second AP, the Operating Class And Channel List subfield is used to indicate primary channel information of each BSS that is being advertised by the second frame, and the primary channel information indicated by the Operating Class And Channel List subfield includes primary channel information of the first AP and the primary channel information of the at least one second AP.

Optionally, the second frame specifically includes a Type subfield, an ID subfield, a Type Dependent Control subfield and a plurality of information groups, where the Type subfield is used to indicate the type of the second frame, the ID subfield is set to 12 LSBs of the compressed MAC address of the AP MLD, the Type Dependent Control subfield is set to 12 MSBs of the compressed MAC address of the AP MLD, the plurality of information groups are used to indicate primary channel information of each BSS that is being advertised by the second frame, the primary channel information indicated by the plurality of information group includes primary channel information of the first AP and the primary channel information of the at least one second AP, each of the plurality of information group includes a Link ID subfield and an Operating Class And Channel subfield, the Link ID subfield is used to indicate a link ID of a link for which a corresponding BSS is being advertised by the second frame, and the Operating Class And Channel subfield is used to indicate primary channel information of a corresponding BSS indicated by the Link ID subfield in a same information group.

Optionally, the communication unit 11 and/or the processing unit 12 is specifically used for generating a request primitive on the SME, where the request primitive includes a discovery channel list which is used to indicate one or more discovery channels to be scanned; performing scanning on the one or more discovery channels to receive the second frame on a MAC layer; and returning a confirm primitive to the SME based on the second frame on the MAC layer; where the confirm primitive includes at least one of the following parameters: an indicator used to indicate that an AP MLD is discovered, a Transmitter ID used to indicate 12 LSBs of a compressed MAC address of the AP MLD, a CompressedMLDMACAddress_MSB used to indicate 12 MSBs of the compressed MAC address of the AP MLD, a Compressed SSID used to indicate 16 LSBs of a short SSID of the AP MLD, a Link ID Bitmap or Link ID List used to specify one or more APs affiliated with the AP MLD, an OperatingChannelList used to specify a primary channel of each of one or more APs affiliated with the AP MLD, and a RSSI used to indicate a RSSI of the first AP.

Optionally, the request primitive further includes at least one of the following parameters: an indicator used to indicate that an AP MLD is to be discovered, a Transmitter ID used to indicate 12 LSBs of a compressed MAC address of the AP MLD to be discovered, a CompressedMLDMACAddress_MSB used to indicate 12 MSBs of the compressed MAC address of the AP MLD to be discovered, and a Compressed SSID used to indicate 16 LSBs of a short SSID of the AP MLD to be discovered.

Optionally, the communication unit 11 is also used for receiving a third frame from the first AP, where the third frame includes a compressed MAC address of the AP MLD and primary channel information of at least one second AP affiliated with the AP MLD, and the type of the third frame is different from that of a legacy WUR Discovery frame.

Optionally, the first frame includes a WUR Discovery element, and the discovery information for the first AP is carried in the WUR Discovery element; or the first frame includes a WUR Discovery element and an RNR element, the WUR Discovery element and the RNR element include the information of the AP MLD, the RNR element includes a part of the discovery information for the first AP, and the WUR Discovery element does not include the part of the discovery information for the first AP.

When the apparatus 10 is used to implement the functions of the AP MLD in the method embodiments described above, the communication unit 11 is used for generating a first frame through a first AP affiliated with the AP MLD, where the first frame includes discovery information for the first AP, and the discovery information for the first AP includes information of the AP MLD; and transmitting the first frame through the first AP.

Optionally, the information of the AP MLD includes at least one of the following parameters: an AP MLD ID of the AP MLD, a link ID of the first AP within the AP MLD or a MAC address of the AP MLD.

Optionally, the first frame further includes discovery information for at least one second AP and/or discovery information for at least one third AP, where each second AP is an AP affiliated with the AP MLD, discovery information for each second AP includes the information of the AP MLD, each third AP is an AP affiliated with a neighboring AP MLD of the AP MLD, and discovery information for each third AP includes an information of an AP MLD with which the third AP is affiliated.

Optionally, the first frame further includes discovery information for at least one fourth AP, where each fourth AP is a neighboring AP of the first AP, and discovery information for each fourth AP includes information of the fourth AP.

Optionally, the communication unit 11 is also used for transmitting a second frame through the first AP based on the discovery information for the first AP, where the second frame is used to discover the first AP, and includes primary channel information of the first AP.

Optionally, the type of the second frame is different from that of a legacy WUR Discovery frame, and the second frame further includes a compressed MAC address of the AP MLD and primary channel information of at least one second AP affiliated with the AP MLD.

Optionally, the second frame specifically includes a Type subfield, ID subfield, a Type Dependent Control subfield, a Link ID Bitmap subfield and an Operating Class And Channel List subfield, where the Type subfield is used to indicate the type of the second frame, the ID subfield is set to 12 LSBs of the compressed MAC address of the AP MLD, the Type Dependent Control subfield is set to 12 MSBs of the compressed MAC address of the AP MLD, the Link ID Bitmap subfield is used to indicate a link ID of each link for which a corresponding BSS is being advertised by the second frame, link IDs indicated by the Link ID Bitmap subfield include a link ID of the first AP and a link ID of the at least one second AP, the Operating Class And Channel List subfield is used to indicate primary channel information of each BSS that is being advertised by the second frame, and the primary channel information indicated by the Operating Class And Channel List subfield includes primary channel information of the first AP and the primary channel information of the at least one second AP.

Optionally, the second frame specifically includes a Type subfield, an ID subfield, a Type Dependent Control subfield, and a plurality of information groups, where the Type subfield is used to indicate the type of the second frame, the ID subfield is set to 12 LSBs of the compressed MAC address of the AP MLD, the Type Dependent Control subfield is set to 12 MSBs of the compressed MAC address of the AP MLD, the plurality of information groups are used to indicate primary channel information of each BSS that is being advertised by the second frame, the primary channel information indicated by the plurality of information groups includes primary channel information of the first AP and the primary channel information of the at least one second AP, each of the plurality of information group includes a Link ID subfield and an Operating Class And Channel subfield, the Link ID subfield is used to indicate a link ID of a link for which a corresponding BSS is being advertised by the second frame, and the Operating Class And Channel subfield is used to indicate primary channel information of the corresponding BSS indicated by the Link ID subfield in a same information group.

Optionally, the communication unit 11 is also used for transmitting a third frame through the first AP, where the third frame includes a compressed MAC address of the AP MLD and primary channel information of at least one second AP affiliated with the AP MLD, and the type of the third frame is different from that of a legacy WUR Discovery frame.

Optionally, the first frame includes a WUR Discovery element, and the discovery information for the first AP is carried in the WUR Discovery element; or the first frame includes a WUR Discovery element and an RNR element, the WUR Discovery element and the RNR element include the information of the AP MLD, the RNR element includes a part of the discovery information for the first AP, and the WUR Discovery element does not include the part of the discovery information for the first AP.

More detailed descriptions of the communication unit 11 and the processing unit 12 may refer to the relevant descriptions in the method embodiments described above, and not be repeated here.

As shown in FIG. 14, an apparatus 20 may include a processor 21. The processor 21 is coupled to a memory 23 which is used to store instructions. While the apparatus 20 is used to implement the method described above, the processor 21 is used to execute the instructions in the memory 23 to implement the functions of the processing unit 12 described above.

Optionally, the apparatus 20 further includes the memory 23.

Optionally, the apparatus 20 further includes an interface circuit 22. The processor 21 is coupled to the interface circuit 22. Understandably, the interface circuit 22 may be a transceiver or I/O interface. When the apparatus 20 is used to implement the method described above, the processor 21 is used to execute the instructions to implement the functions of processing unit 12 and the interface circuit 22 is used to implement the functions of communication unit 11.

Illustratively, when the apparatus 20 is a chip applied in the STA or the AP MLD, the chip implements the function of the STA or the AP MLD. The chip receives information from other modules (such as a radio frequency module or an antenna) in the STA or the AP MLD, and the information is sent to the STA or the AP MLD by another device. Optionally, the chip sends information to other modules (such as a radio frequency module or an antenna) in the STA or the AP MLD, and the information is sent to another device.

This application also provides a first AP affiliated with an AP MLD, which includes one or more processors, where the one or more processors are configured to execute a computer program stored in a memory to implement any of the methods provided by the above-mentioned method embodiments.

This application also provides a processor which is configured to execute a computer program stored in a memory to implement any of the methods provided by the above-mentioned method embodiments.

This application also provides is a computer-readable medium on which a program is recorded, where the program, when executed, enables a computer to implement any of the methods provided by the above-mentioned method embodiments.

This application also provides a computer program product, where the computer program product includes instructions to implement any of the methods provided by the above-mentioned method embodiments.

This application also provides a computer program, where the computer program, when executed, enables a computer to implement any of the methods provided by the above-mentioned method embodiments.

This application also provides a chip, where the chip includes at least one processor and a communication interface, where the at least one processor is used to obtain a computer program or instructions stored in a memory through the communication interface to implement any of the methods provided by the above-mentioned method embodiments.

This application also provides a communication system, where the communication system includes the station and/or the AP MLD mentioned above.

A person of ordinary skill in the art may be aware that units and algorithm steps in the examples described with reference to the embodiments disclosed in this specification may be implemented by electronic hardware or a combination of computer software and electronic hardware. Whether the functions are performed by hardware or software depends on a particular application and a design constraint condition of the technical solutions. A person skilled in the art may use different methods to implement the described functions for each particular application, but it should not be considered that the implementation goes beyond the scope of this application.

It may be clearly understood by a person skilled in the art that for the purpose of convenient and brief description, for a detailed working process of the described system, apparatus, and unit, refer to a corresponding process in the foregoing method embodiments.

In the several embodiments provided in this application, it should be understood that the disclosed system, apparatus, and method may be implemented in other manners. For example, the described apparatus embodiments are merely examples. For example, the division into units is merely logical function division and may be other division during actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in an electronic form, a mechanical form, or another form.

The units described as separate parts may or may not be physically separate, and parts displayed as units may or may not be physical units, may be located in one position, or may be distributed on a plurality of network units. Some or all of the units may be selected based on an actual requirement to achieve the objectives of the solutions of the embodiments.

In addition, functional units in the embodiments of this application may be integrated into one processing unit, or each of the units may exist alone physically, or two or more units are integrated into one unit.

When the functions are implemented in a form of a software functional unit and sold or used as an independent product, the functions may be stored in a computer-readable storage medium. Based on such an understanding, the technical solutions of this application essentially, or the part contributing to the current technology, or some of the technical solutions may be implemented in a form of a software product. The software product is stored in a storage medium, and includes several instructions for instructing a computer device (which may be a personal computer, a server, or a network device) to perform all or some of the steps of the methods described in the embodiments of this application. The foregoing storage medium includes any medium that can store program code, such as a USB flash drive, a removable hard disk, a read-only memory (read-only memory, ROM), a random access memory (random access memory, RAM), a magnetic disk, or a compact disc.

The foregoing descriptions are merely specific implementations of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

What is claimed is:

1. A communication method, comprising:
receiving, by a station, a first frame, wherein the first frame comprises discovery information for a first access point (AP) affiliated with an AP multi-link device (MLD), and the discovery information for the first AP comprises information of the AP MLD;
receiving, by the station, a second frame from the first AP, wherein the second frame is used to discover the first AP; and
determining, by the station, that the first AP is affiliated with the AP MLD according to the discovery information for the first AP and the second frame.

2. The method according to claim 1, wherein the information of the AP MLD comprises at least one of the following parameters:
an AP MLD ID of the AP MLD, a link ID of the first AP within the AP MLD or a medium access control (MAC) address of the AP MLD.

3. The method according to claim 1, wherein the first frame further comprises discovery information for at least one second AP and/or discovery information for at least one third AP, wherein each second AP is an AP affiliated with the AP MLD, discovery information for each second AP comprises the information of the AP MLD, each third AP is an AP affiliated with a neighboring AP MLD of the AP MLD, and discovery information for each third AP comprises information of an AP MLD with which the third AP is affiliated.

4. The method according to claim 3, wherein the first frame further comprises discovery information for at least one fourth AP, wherein each fourth AP is a neighboring AP of the first AP, and discovery information for each fourth AP comprises information of the fourth AP.

5. The method according to claim 1, wherein a type of the second frame is different from that of a legacy wake-up radio (WUR) discovery frame, and the second frame comprises a compressed medium access control (MAC) address of the AP MLD and primary channel information of at least one second AP affiliated with the AP MLD.

6. The method according to claim 5, wherein the second frame specifically comprises a Type subfield, an ID subfield, a Type Dependent Control subfield, a Link ID Bitmap subfield and an Operating Class And Channel List subfield, wherein the Type subfield is used to indicate the type of the second frame, the ID subfield is set to 12 least significant bits (LSBs) of the compressed MAC address of the AP MLD, the Type Dependent Control subfield is set to 12 most significant bits (MSBs) of the compressed MAC address of the AP MLD, the Link ID Bitmap subfield is used to indicate a link ID of each link for which a corresponding basic service set (BSS) is being advertised by the second frame, link IDs indicated by the Link ID Bitmap subfield comprise a link ID of the first AP and a link ID of the at least one second AP, the Operating Class And Channel List subfield is used to indicate primary channel information of each BSS that is being advertised by the second frame, and the primary channel information indicated by the Operating Class And Channel List subfield comprises primary channel information of the first AP and the primary channel information of the at least one second AP.

7. The method according to claim 5, wherein the second frame specifically comprises a Type subfield, an ID subfield, a Type Dependent Control subfield, and a plurality of information groups, wherein the Type subfield is used to indicate the type of the second frame, the ID subfield is set to 12 least significant bits (LSBs) of the compressed MAC address of the AP MLD, the Type Dependent Control subfield is set to 12 most significant bits (MSBs) of the compressed MAC address of the AP MLD, the plurality of information groups are used to indicate primary channel information of each BSS that is being advertised by the second frame, the primary channel information indicated by the plurality of information groups comprises primary channel information of the first AP and the primary channel information of the at least one second AP, each of the plurality of information group comprises a Link ID subfield and an Operating Class And Channel subfield, the Link ID subfield is used to indicate a link ID of a link for which a corresponding BSS is being advertised by the second frame, and the Operating Class And Channel subfield is used to indicate primary channel information of the corresponding BSS indicated by the Link ID subfield in a same information group.

8. The method according to claim 5, wherein the receiving the second frame from the first AP further comprises:
generating, by the station, a request primitive on a system management entity (SME), wherein the request primitive comprises a discovery channel list which is used to indicate one or more discovery channels to be scanned;
performing, by the station, scanning on the one or more discovery channels to receive the second frame on a MAC layer; and
returning, by the station, a confirm primitive to the SME based on the second frame on the MAC layer, wherein the confirm primitive comprises at least one of the following parameters:
an indicator used to indicate that an AP MLD is discovered;
a Transmitter ID used to indicate 12 least significant bits (LSBs) of the compressed MAC address of the AP MLD;
a CompressedMLDMACAddress_MSB used to indicate 12 most significant bits (MSBs) of the compressed MAC address of the AP MLD;
a Compressed Service Set Identifier (SSID) used to indicate 16 LSBs of a short SSID of the AP MLD;
a Link ID Bitmap or Link ID List used to specify one or more APs affiliated with the AP MLD;
an OperatingChannelList used to specify a primary channel of each of the one or more APs affiliated with the AP MLD; and
a received signal strength indicator (RSSI) used to indicate an RSSI of the first AP.

9. The method according to claim 8, wherein the request primitive further comprises at least one of the following parameters:
an indicator used to indicate that an AP MLD is to be discovered;
a Transmitter ID used to indicate 12 LSBs of a compressed MAC address of the AP MLD to be discovered;
a CompressedMLDMACAddress_MSB used to indicate 12 MSBs of the compressed MAC address of the AP MLD to be discovered; and
a Compressed Service Set Identifier (SSID) used to indicate 16 LSBs of a short SSID of the AP MLD to be discovered.

10. The method according to claim 1, wherein the method further comprises:
receiving, by the station, a third frame from the first AP, wherein the third frame comprises a compressed medium access control (MAC) address of the AP MLD and primary channel information of at least one second AP affiliated with the AP MLD, and a type of the third frame is different from that of a legacy wake-up radio (WUR) discovery frame.

11. The method according to claim 1, wherein the first frame comprises a wake-up radio (WUR) discovery element, and the discovery information for the first AP is carried in the WUR Discovery element; or the first frame comprises a WUR Discovery element and a reduced neighbor report (RNR) element, the WUR Discovery element and the RNR element comprise the information of the AP MLD, the RNR element comprises a part of the discovery information for the first AP, and the WUR Discovery element does not comprise the part of the discovery information for the first AP.

12. A communication method, comprising:
generating, by an access point (AP) multi-link device (MLD), a first frame through a first AP affiliated with the AP MHLD, wherein the first frame comprises discovery information for the first AP, and the discovery information for the first AP comprises information of the AP MLD; and
transmitting, by the AP MLD, the first frame through the first AP.

13. The method according to claim 12, wherein the information of the AP MLD comprises at least one of the following parameters:
an AP MLD ID of the AP MLD, a link ID of the first AP within the AP MLD or a medium access control (MAC) address of the AP MLD.

14. The method according to claim 12, wherein the first frame further comprises discovery information for at least one second AP and/or discovery information for at least one third AP, wherein each second AP is an AP affiliated with the AP MLD, discovery information for each second AP comprises the information of the AP MLD, each third AP is an AP affiliated with a neighboring AP MLD of the AP MLD, and discovery information for each third AP comprises information of an AP MLD with which the third AP is affiliated.

15. The method according to claim 14, wherein the first frame further comprises discovery information for at least one fourth AP, wherein each fourth AP is a neighboring AP of the first AP, and discovery information for each fourth AP comprises information of the fourth AP.

16. The method according to claim 12, wherein the method further comprises:
transmitting, by the AP MILD, a second frame through the first AP based on the discovery information for the first AP, wherein the second frame is used to discover the first AP.

17. The method according to claim 16, wherein a type of the second frame is different from that of a legacy wake-up radio (WUR) discovery frame, and the second frame comprises a compressed medium access control (MAC) address of the AP MLD and primary channel information of at least one second AP affiliated with the AP MLD.

18. The method according to claim 17, wherein the second frame specifically comprises a Type subfield, an ID subfield, a Type Dependent Control subfield, a Link ID Bitmap subfield and an Operating Class And Channel List subfield, wherein the Type subfield is used to indicate the type of the second frame, the ID subfield is set to 12 least significant bits (LSBs) of the compressed MAC address of the AP MLD, the Type Dependent Control subfield is set to 12 most significant bits (MSBs) of the compressed MAC address of the AP MLD, the Link ID Bitmap subfield is used to indicate a link ID of each link for which a corresponding BSS is being advertised by the second frame, link IDs indicated by the Link ID Bitmap subfield comprise a link ID of the first AP and a link ID of the at least one second AP, the Operating Class And Channel List subfield is used to indicate primary channel information of each BSS that is being advertised by the second frame, and the primary channel information indicated by the Operating Class And Channel List subfield comprises primary channel information of the first AP and the primary channel information of the at least one second AP.

19. The method according to claim 17, wherein the second frame specifically comprises a Type subfield, an ID subfield, a Type Dependent Control subfield, and a plurality of information groups, wherein the Type subfield is used to indicate the type of the second frame, the ID subfield is set to 12 least significant bits (LSBs) of the compressed MAC address of the AP MLD, the Type Dependent Control subfield is set to 12 most significant bits (MSBs) of the compressed MAC address of the AP MLD, the plurality of information groups are used to indicate primary channel information of each BSS that is being advertised by the second frame, the primary channel information indicated by the plurality of information groups comprises primary channel information of the first AP and the primary channel information of the at least one second AP, each of the plurality of information group comprises a Link ID subfield and an Operating Class And Channel subfield, the Link ID subfield is used to indicate a link ID of a link for which a corresponding BSS is being advertised by the second frame, and the Operating Class And Channel subfield is used to indicate primary channel information of the corresponding BSS indicated by the Link ID subfield in a same information group.

20. The method according claim 12, wherein the method further comprises:
transmitting, by the AP MLD, a third frame through the first AP, wherein the third frame comprises a compressed medium access control (MAC) address of the AP MLD and primary channel information of at least one second AP affiliated with the AP MLD, and a type of the third frame is different from that of a legacy wake-up radio (WUR) discovery frame.
